(19) United States
(12) Patent Application Publication
(10) Pub. No.: US 2012/0082373 A1
(43) Pub. Date: Apr. 5, 2012

(54) METHOD AND SYSTEM FOR DETERMINING WHETHER A POINT IS INSIDE A POLYHEDRON

(75) Inventor: Waleed MEBANE, Belmont, CA (US)

(73) Assignee: Konica Minolta Systems Laboratory, Inc., Huntington Beach, CA (US)

(21) Appl. No.: 12/894,717

(22) Filed: Sep. 30, 2010

(51) Int. Cl. G06K 9/00

(52) U.S. Cl. 382/162

(57) ABSTRACT

A method for determining if a test point is within a color gamut of an image processing device, which includes: (a) selecting a test point which may or may not be within the color gamut of the image processing device, and wherein the color gamut of the image processing device is defined by at least one polyhedron; (b) forming a test plane containing the test point and two other points, and which intersects an inner portion of the at least one polyhedron; (c) generating a polygon from the intersection of the test plane and an outer boundary of the at least one polyhedron, the polygon having a closed path, which forms a boundary of the polygon; (d) generating a test ray extending from the test point and which is within the test plane; and (e) counting a number of times the test ray crosses the boundary of the polygon.

### FIELD OF THE INVENTION

This invention relates to relates to the field of graphics and color management, and in particular, to a system and method for determining if a test point is within a polyhedron or color coordinate space of a color gamut of an image processing device.

### BACKGROUND OF THE INVENTION

Graphical output devices that deal with the reproduction of color images typically have a range of colors that can be accurately rendered by the device. The range of colors that a device can render is termed the gamut or color gamut of the device. The range of colors that are visually perceptible to the human eye can be modeled mathematically using a device independent model such as, for example, Commission Internationale de I'Eclairage XYZ (CIE XYZ) or CIE LAB color space, in which colors may be unambiguously specified without reference to external factors. The color gamut, for example, in a printer can be a 3-dimensional shape indicated in a color coordinate space, where the boundaries of the color space indicate the capability of the device. Because most devices are incapable of rendering the totality of visible colors, the color gamut of a typical device is some subset of the visually perceptible color space. When a color is beyond the physical rendering capability of a device, the color is termed as “out of gamut” for the device.

When colors represented by a color space in an image processing device are converted to a different color space in a destination device some colors in the image processing device may be out of the gamut of the destination device. For example, digital images, which can be specified in a Red-Blue-Green (“RGB”) color space, are typically converted to a Cyan-Magenta-Yellow-Black (“CMYK”) color space during the printing process. Colors in the input color space that are out of gamut in the destination color space may be approximated in the destination color space. For example, RGB colors that are out of gamut in the CMYK color space may be approximated by some combination of the CMYK color components.

One approach approximates an out of gamut color in a destination device by using a color within the gamut of the destination device that has a minimum color difference with respect to the input color. The minimum color difference (“MinCD”) may be calculated using a variety of approaches specified by CIE, or other organizations. In practice, the minimum color difference can seek to reduce the perceptual or colorimetric color differences between the out-of-gamut colors being approximated by in-gamut colors. However, the application of such methods has typically involved repeated searching of the destination gamut surface to determine in-gamut and out-of-gamut colors. Additional processing involving the destination gamut surface may be performed to determine in-gamut approximations for out of gamut colors. Such repeated searching of and processing related to the destination gamut surface can be computationally expensive and inefficient. Thus, there is a need for an efficient method and system for identifying and determining if a point is within a polyhedron or color gamut of a device, and which simplifies the handling of the intersection of a test ray with edges and vertices as compared with conventional ray crossing methods.

### OBJECTS AND SUMMARY

The present invention has been made in consideration of the above issues, and provides an improved image processing and system and method for determining if a test point is within a color coordinate space of a device gamut, wherein the color coordinate space is a polyhedron and a determination is made whether a test point is inside or outside of the color gamut of the device.

In accordance with an exemplary embodiment, a method for determining if a test point is within a color gamut of an image processing device, the method comprises: (a) selecting a test point which may or may not be within the color gamut of the image processing device, and wherein the color gamut of the image processing device is defined by at least one polyhedron; (b) forming a test plane containing the test point and two other points, and which intersects an inner portion of the at least one polyhedron; (c) generating a polygon from the intersection of the test plane and an outer boundary of the at least one polyhedron, the polygon having a closed path, which forms a boundary of the polygon; (d) generating a test ray extending from the test point and which is within the test plane; and (e) counting a number of times the test ray crosses the boundary of the polygon, and wherein if the number of times the test ray crosses the boundary of the polygon is even, the test point is outside of the at least one polyhedron, and if the number of times the test ray crosses the boundary of the polygon is odd, the test point is inside of the at least one polyhedron.

In accordance with another exemplary embodiment, a computer program product comprising a non-transitory computer usable medium having a computer readable code embodied therein for controlling a device, the computer readable program code configured to determine if a test point is within a color gamut of an image processing device, the process comprising the steps of: (a) selecting a test point which may or may not be within the color gamut of the image processing device, and wherein the color gamut of the image processing device is defined by at least one polyhedron; (b) forming a test plane containing the test point and two other points, and which intersects an inner portion of the at least one polyhedron; (c) generating a polygon from the intersection of the test plane and an outer boundary of the at least one polyhedron, the polygon having a closed path, which forms a boundary of the polygon; (d) generating a test ray extending from the test point and which is within the test plane; and (e) counting a number of times the test ray crosses the boundary of the polygon, and wherein if the number of times the test ray crosses the boundary of the polygon is even, the test point is outside of the at least one polyhedron, and if the number of times the test ray crosses the boundary of the polygon is odd, the test point is inside of the at least one polyhedron.

In accordance with a further exemplary embodiment, an imaging device comprises: a memory unit, the memory unit having a firmware application which determines if a test point is within a color gamut of an image processing device, the method comprising: (a) selecting a test point which may or may not be within the color gamut of the image processing device, and wherein the color gamut of the image processing device is defined by at least one polyhedron; (b) forming a test plane containing the test point and two other points, and which intersects an inner portion of the at least one polyhedron; (c) generating a polygon from the intersection of the test plane and an outer boundary of the at least one polyhedron, the polygon having a closed path, which forms a boundary of the polygon; (d) generating a test ray extending from the test point and which is within the test plane; and (e) counting a number of times the test ray crosses the boundary of the polygon, and wherein if the number of times the test ray crosses the boundary of the polygon is even, the test point is outside of the at least one polyhedron, and if the number of times the test ray crosses the boundary of the polygon is odd, the test point is inside of the at least one polyhedron.

It is to be understood that both the foregoing general description and the following detailed description are exemplary and explanatory and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is an exemplary block diagram of a system using a computing device coupled to an output device in accordance with an exemplary embodiment.

FIG. 2 is a diagram of a polyhedron in the form of an octagonal prism.

FIG. 3 is a diagram of polygon formed by intersecting a horizontal plane through the polyhedron of FIG. 2, and having two test points in accordance with an exemplary embodiment.

FIG. 4 is a flow chart illustrating a method for determining if a test point is within a color gamut of an image processing device, wherein the color gamut is defined by at least one polyhedron, and which can be reproduced by the image processing device in accordance with an exemplary embodiment.

FIG. 5 is a flow chart illustrating a method for determining if a test point is within a color gamut of an image processing device, wherein the color gamut is defined by at least one polyhedron, and which can be reproduced by the device in accordance with another exemplary embodiment.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

In accordance with an exemplary embodiment, in color reproduction, a color gamut of a device, for example, a printer, is a 3-dimensional shape indicated in a color coordinate space, such as RGB (red-green-blue) color space or the CIE LAB colorimetric coordinate space. The boundaries of the shape indicate the capability of the device. All of the space outside of the boundary contains colors that cannot be produced by the device. The space inside of the boundary (or inner portion) and on the surface contains all of the colors, which can be produced by the device. Therefore, whether a point in the color coordinate space is inside of the gamut determines whether the color can be produced by the device or whether further processing is necessary to find a suitable alternative color that the device is capable of reproducing. In accordance with an exemplary embodiment, the color gamut of the image processing device is defined by at least one polyhedron, and more preferably one polyhedron. However, it can be appreciated that in accordance with an alternative embodiment, the color gamut of the image processing device can be defined by one or more polyhedrons.

It can be appreciated that in accordance with an exemplary embodiment, the image processing device can be a computing device such as a personal computer or laptop computer having a monitor, which displays a color gamut, a digital camera, a scanner, a computer peripheral and/or a digital processing device. Alternatively, in accordance with another exemplary embodiment, the image processing device can be an output device such as an image forming apparatus and/or printer having color capabilities.

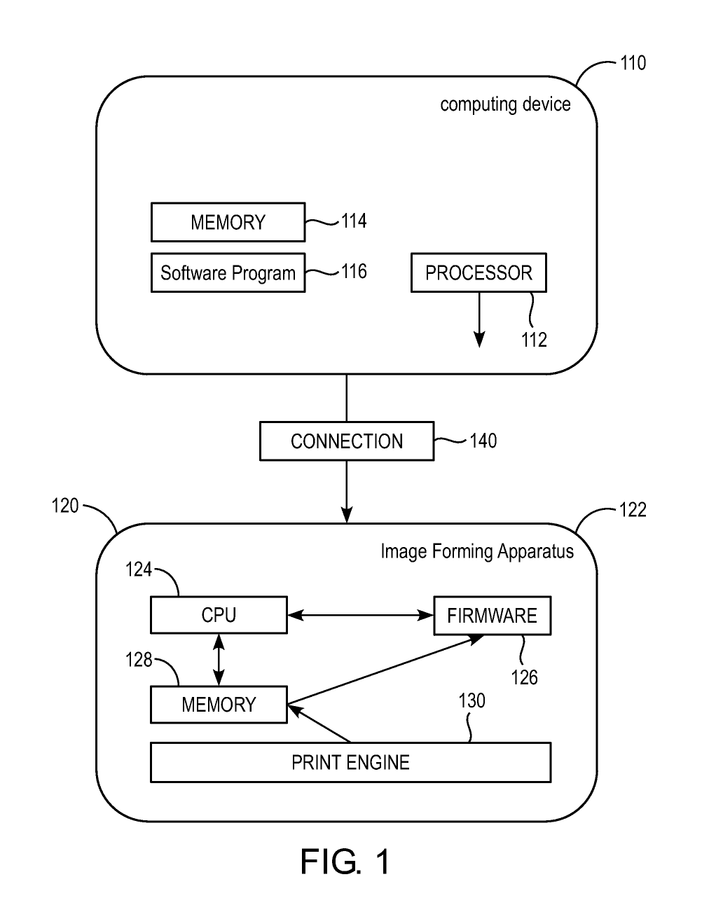

FIG. 1 illustrates an exemplary block diagram of a system 100 using a computing device 110 coupled to an output device 120, which is shown as exemplary image forming apparatus 122 (i.e., printer). It can be appreciated that the methods disclosed may be performed on any image (i.e., graphic) processing device that is capable of performing color conversion operations including computing devices 110, output devices 120, and/or other devices that perform color space conversions, color management, and/or color translations. The computing device 100 can include a processor 112 and one or more memories 114 for storing software programs 116 and data (such as files to be printed). It can be appreciated that the devices as described herein can receive input in a first color space and produce output in a second color space, which in some instances may be different from the first color space.

In accordance with an exemplary embodiment, the image forming apparatus 122 is preferably a device configured to produce physical documents from electronic data including, but not limited to, electro-photographic printers, such as laser printers and LED printers, ink-jet printers, thermal printers, laser imagers, and offset printers. The image forming apparatus 122 may have image transmitting/receiving function, image scanning function, and/or copying function, as installed in facsimile machines and digital copiers. The methods and apparatus described in this document may also be applied to these various printer device types with appropriate modifications and in a manner consistent with embodiments disclosed herein.

It can be appreciated that the computing device 110 may be a general purpose computer that includes a monitor to display the input color data, or alternatively, an image generating device such as a digital camera. In accordance with an exemplary embodiment, the computing device 110 is preferably coupled to the image forming apparatus 120 via a wired or wireless connection 140 using conventional communication protocols and/or data port interfaces. The connection 140 can be any communication channel that allows transmission of data between the devices 110, 120.

In accordance with an exemplary embodiment, the computing device 110 may use one color space to represent the color data, such as, an RGB color space, an sRGB color space, or other types of color spaces. In addition, the output device 120 may use a color space native to the image forming apparatus such as a CMY color space, a CMYK color space, or some other type of color space to represent color data prior to printing. It can be appreciated that in some embodiments, the native color space of output device 120 may not match the color space of computing device 110. Therefore, a color conversion of the color data from the color space to the native color space of the output device 120 may be performed prior to printing the color data using the output device 120. In some embodiments, one or more color space conversions may be performed by using a conversion to an intermediate color space such as a Profile Connection Space (“PCS”), which in one instance may be a CIE XYZ color space, or a CIE LAB colorimetric coordinate space.

In accordance with an exemplary embodiment, the output device 120 is an image forming apparatus 122, which preferably includes a bus that couples CPU 124, firmware 126, memory 128, and a print engine 130. The image forming apparatus 122 also preferably includes other Application Specific Integrated Circuits (ASICs), and/or Field Programmable Gate Arrays (FPGAs) that are capable of executing portions of an application to perform color space conversions, gamut mapping, color translations, and other color management routines in a manner consistent with disclosed embodiments. In addition, the image forming apparatus 122 is preferably capable of executing software including a printer operating system and other appropriate application software, including software to perform color management functions.

In accordance with an exemplary embodiment, a method for determining if a test point is within a color gamut of image forming device is disclosed herein, wherein the color gamut is comprised of at least one polyhedron, and represents colors which can be reproduced by the image processing device. The method comprises the steps of (a) selecting a test point which may or may not be within the color gamut of the image forming device, and wherein the color gamut of the image forming device is defined by at least one polyhedron; (b) forming a test plane containing the test point and two other points, and which intersects an inner portion of the at least one polyhedron; (c) generating a polygon from the intersection of the test plane and an outer boundary of the at least one polyhedron, the polygon having a closed path, which forms a boundary of the polygon; and (d) generating a test ray extending from the test point and which is within the test plane. In accordance with an exemplary embodiment, in step (e) if the test ray extends across the boundary of the polygon, the number of times the test ray crosses the boundary of the polygon is counted, and if the number of times the test ray crosses the boundary of the polygon is even, the test point is outside of the at least one polyhedron, and if the number of times the test ray crosses the boundary of the polygon is odd, the test point is inside of the at least one polyhedron. If the test point does not lie within the at least one polyhedron and the color gamut of the image processing device, an equivalent color within the image processing device is preferably obtained via further processing.

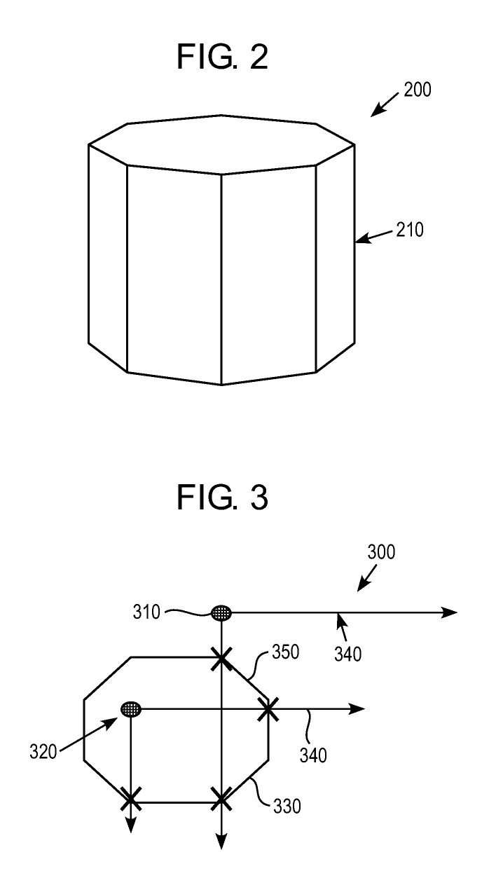

FIG. 2 is a diagram 200 of a polyhedron 210 in the form of an octagonal prism. It can be appreciated that a polyhedron is a geometric solid in three dimensions with flat faces and straight edges. Examples of polyhedrons include tetrahedrons, triangular prisms, cubes, pentagonal prisms, truncated octahedrons, dodecahedrons, octahedrons, and truncated cubes.

FIG. 3 is a diagram 300 of horizontal cross-section of the octagonal prism as shown in FIG. 2, generated by intersecting a plane with an inner portion of the at least one polyhedron 200. In accordance with an exemplary embodiment, a test plane (not shown) containing a test point 310, 320 and two other points is generated and intersects an inner portion of the at least one polyhedron 200. The intersection of the test plane with the outer boundary (or outer portion) of the at least one polyhedron generates a polygon 330. It can be appreciated that a polygon 330 is a plane figure that is bounded by a closed path or circuit, composed of a finite sequence of straight line segments. In accordance with an exemplary embodiment, a test ray 340 is then generated, which extends from the test point 310, 320, and which is within the test plane. The number of times the test ray 340 crosses the boundary 350 of the polygon 330 is then counted. In accordance with an exemplary embodiment, and as shown in FIG. 3, if the number of times the test ray 340 crosses the boundary 350 of polygon 330 is even, the test point 310 is outside of the polyhedron 200, and if the number of times the test ray crosses the boundary of the polygon 330 is odd, the test point 320 is inside of the polyhedron 200.

It can be appreciated that the color gamut (or color coordinate space) of an image processing device can be a RGB (red-green-blue) color space, a CIE LAB colorimetric coordinate space, or alternatively, any color space, which can be partitioned into at least one polyhedron, and wherein the at least one polyhedron corresponds to the color gamut (or color space) of the image processing device, and which can be reproduced by the device. If the test point is within the boundary of the at least one polyhedron, the color can be reproduced by the device. Alternatively, if the test point is outside the boundary of the at least one polyhedron, the color cannot be reproduced by the device and further processing is necessary to find a suitable alternative color that the device is capable of reproducing.

In accordance with an exemplary embodiment, the test plane can be formed by holding one dimension constant and assigning different values to the two other points describing the plane. In addition, the test plane can be formed by selecting such points, which are expected to pass through the fewest number of facets of the polyhedron. For example, in accordance with an exemplary embodiment, the number of facets which the test plane may intersect can be estimated by sorting the facets, and choosing the test plane with a fixed x, y, or z value depending on how many facets are near the x, y, or z value of the test point. Furthermore, for each edge of each facet of the polyhedron, an intersection point between the lines containing the edge and a chosen plane (i.e., test plane) can be found to ensure that the chosen plane passes between the two end points of an edge, and that a portion of the polyhedron lies on one side of the chosen plane and a portion of the polyhedron lies on the other side of the chosen plane.

In accordance with another exemplary embodiment, the polygon can be built by the following method, wherein for each facet of the polyhedron whose edges contain two distinct intersection points with the test plane, a line segment can be added, which is formed by the two distinct intersection points as an edge of the polygon. In addition, the method can include the step of selecting an edge to the left when the test ray intersects a shared vertex.

In accordance with an exemplary embodiment, before performing steps (a)-(e), a test ray can be generated, which extends from the test point and checking whether the test ray intersects any facets of the polyhedron at an edge or vertex. If the test ray does not intersect any facets of the polyhedron at an edge or vertex, the number of times the ray crosses the boundary of the polyhedron are counted, and if the number of times the test ray crosses the boundary of the polyhedron is even, the test point is outside of the polyhedron, and if the number of time the rays crosses the boundary of the polyhedron is odd, the test point is inside of the polyhedron. Furthermore, if the test ray intersects an edge or vertex, steps (a)-(e) are performed to determine if the test point is inside or outside of the polyhedron.

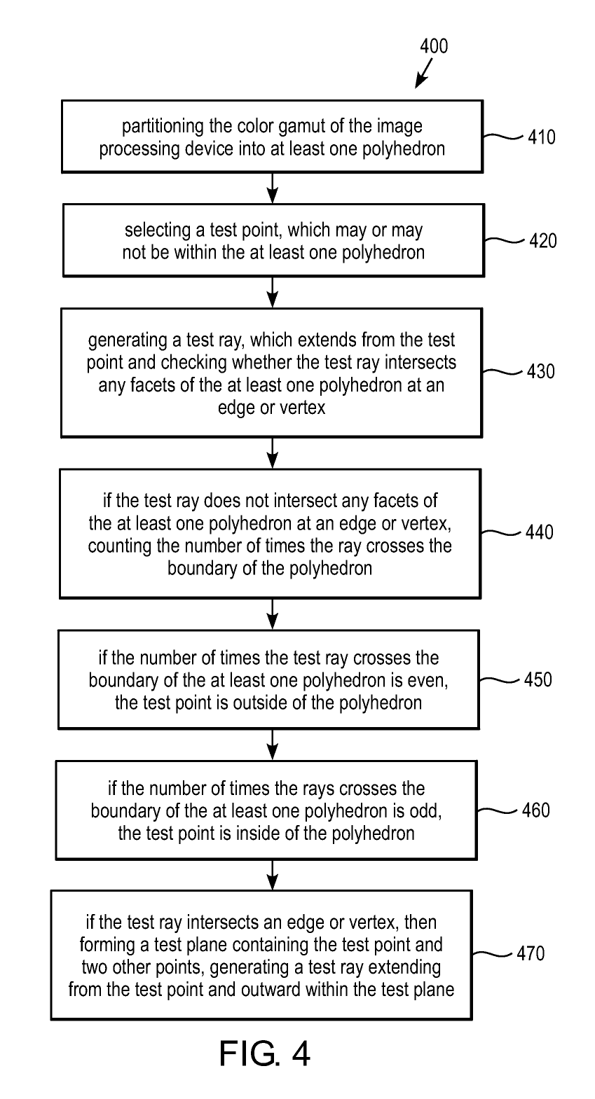

FIG. 4 is a flow chart illustrating a method 400 for determining if a test point is within a color gamut or coordinate space of an image processing device. In step 410, the color gamut (or color coordinate space) of the image processing device is partitioned into at least one polyhedron, which can be reproduced by the device. In step 420, a test point is selected, which may or may not be within the at least one polyhedron. In step 430, a test ray is generated, which extends from the test point and it is checked whether the test ray intersects any facets of the at least one polyhedron at an edge or vertex. In step 440, if the test ray does not intersect any facets of the at least one polyhedron at an edge or vertex, the number of times the ray crosses the boundary of the at least one polyhedron is counted. In step 450, if the number of times the test ray crosses the boundary of the at least one polyhedron is even, the test point is outside of the polyhedron. In step 460, if the number of times the rays crosses the boundary of the at least one polyhedron is odd, the test point is inside of the polyhedron. In step 470, if the test ray intersects an edge or vertex, a test plane is formed containing the test point and two other points, and a test ray is generated extending from the test point and outward within the test plane.

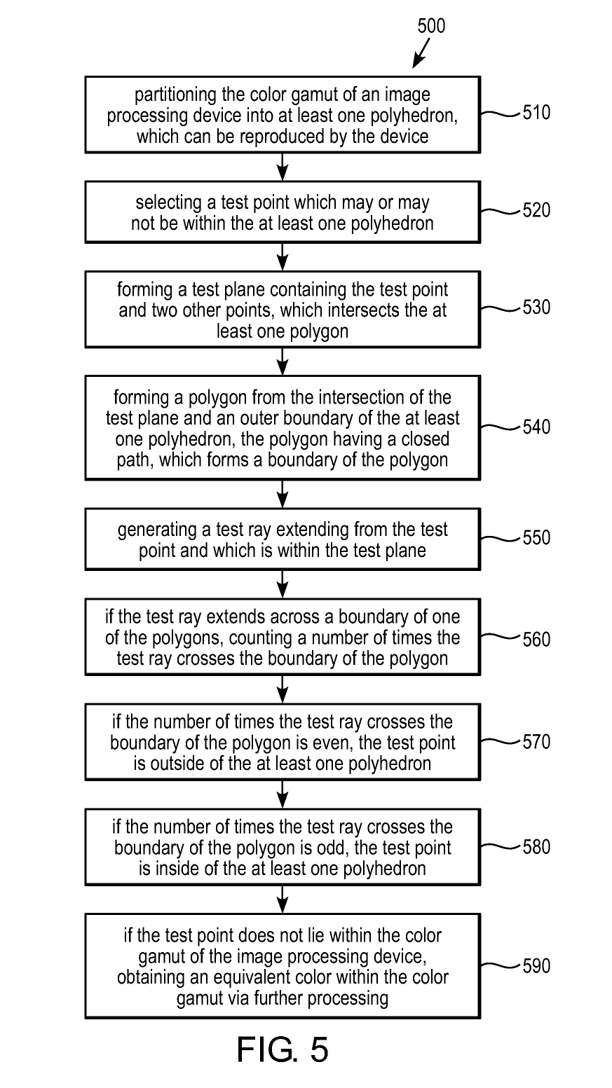

FIG. 5 is a flow chart illustrating another method 500 for determining if a test point is within a color gamut or color coordinate space of an image processing device. In step 510, the color gamut (or color coordinate space) is partitioned into at least one polyhedron, which can be reproduced by the device. In step 520, a test point is selected which may or may not be within one of the at least one polyhedron. In step 530, a test plane is formed containing the test point and two other points, and which intersects an inner portion of the at least one polyhedron. In step 540, forming a polygon from the intersection of the test plane and an outer boundary of the at least one polyhedron, the polygon having a closed path, which forms a boundary of the polygon. In step 550, a test ray is generated extending from the test point and which is within the test plane. In step 560, if the test ray extends across a boundary of one of the polygon, counting a number of times the test ray crosses the boundary of the polygon. In step 570, if the number of times the test ray crosses the boundary of the polygon is even, the test point is outside of the at least one polyhedron. In step 580, if the number of times the test ray crosses the boundary of the polygon is odd, the test point is inside of the at least one polyhedron. In step 590, if the test point does not lie within the color gamut of the device, an equivalent color within the color gamut of the device is obtained via further processing.

It can be appreciated, that color gamut translations from an image processing device to a destination device often involve gamut compression. For example, the color gamut of display devices and graphic cards are typically more expansive than the color gamut of printing devices. Accordingly, pre-existing or manufacturer-provided algorithms in gamut mapping module can map input colors to within the gamut of the output device. In other instances, manufacturer-provided algorithms may be inadequate to map all input colors to the destination space, which requires a suitable alternative color be obtained via further processing.

The methods as described herein can also be implemented by a computer program product comprising a non-transitory computer usable medium having a computer readable code embodied therein method for determining if a test point is within a color coordinate space of a device gamut, wherein the color coordinate space is at least one polyhedron, and wherein the at least one polyhedron corresponds to a color space, which can be reproduced by the device, and wherein the computer readable program code configured to cause the device to display and/or print an image formed by the steps of: a) selecting a test point which may or may not be within the color gamut of the image processing device, and wherein the color gamut of the image processing device is defined by at least one polyhedron; (b) forming a test plane containing the test point and two other points, and which intersects an inner portion of the at least one polyhedron; (c) generating a polygon from the intersection of the test plane and an outer boundary of the at least one polyhedron, the polygon having a closed path, which forms a boundary of the polygon; (d) generating a test ray extending from the test point and which is within the test plane; and (e) counting a number of times the test ray crosses the boundary of the polygon, and wherein if the number of times the test ray crosses the boundary of the polygon is even, the test point is outside of the at least one polyhedron, and if the number of times the test ray crosses the boundary of the polygon is odd, the test point is inside of the at least one polyhedron.

It can be appreciated that the process and method can be introduced into the output device and/or computing device by updating the firmware in the non-volatile memory of the output device and/or software of the computing device. In this regard, the method may be brought to a device or apparatus in a form of a package of install software, and the firmware, which may be divided and/or compressed so that the install software effectively installs the firmware. The package may be steadily stored in a computer readable diskette, such as a compact disk, or may be transmitted through a wire/wireless communication line.

The method described above can be used to print on paper or other suitable printing medium such as thin plastic sheets, etc. The computer readable medium, of course, can be a magnetic recording medium, a magneto-optic recording medium, or any other recording medium which will be developed in future, all of which can be considered applicable to the present invention in all the same way. Duplicates of such medium including primary and secondary duplicate products and others are considered equivalent to the above medium without doubt. Furthermore, even if an embodiment of the present invention is a combination of software and hardware, it does not deviate from the concept of the invention at all. The present invention can be implemented such that its software part has been written onto a recording medium in advance and will be read as required in operation.

Thus, as used in this disclosure and the appended claims, the term “image forming apparatus”, “printer” or “printing device” should be broadly understood to refer to any machine that has a print function, including printers, copiers, and all-in-one machines which have printing, scanning and copying functions. The term “printing” similarly include both printing and copying, i.e., it refers to producing images on a recording medium either from a data received from an external device such as a host computer or from data generated by scanning an original hard copy.

It will be apparent to those skilled in the art that various modifications and variation can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for determining if a test point is within a color gamut of an image processing device, the method comprising:
(a) selecting a test point which may or may not be within the color gamut of the image processing device, and wherein the color gamut of the image processing device is defined by at least one polyhedron;
(b) forming a test plane containing the test point and two other points, and which intersects an inner portion of the at least one polyhedron;
(c) generating a polygon from the intersection of the test plane and an outer boundary of the at least one polyhedron, the polygon having a closed path, which forms a boundary of the polygon;
(d) generating a test ray extending from the test point and which is within the test plane; and
(e) counting a number of times the test ray crosses the boundary of the polygon, and wherein if the number of times the test ray crosses the boundary of the polygon is even, the test point is outside of the at least one polyhedron, and if the number of times the test ray crosses the boundary of the polygon is odd, the test point is inside of the at least one polyhedron.

2. The method of claim 1, wherein if the test ray does not extend across the boundary of the polygon, the test point is outside of the at least one polyhedron.

3. The method of claim 1, wherein if the test point is inside of the polyhedron, the test point is within the color gamut of the image processing device.

4. The method of claim 3, wherein if the test point outside of the polyhedron, the test point is outside the color gamut of the image processing device and further processing is necessary to find a suitable alternative color that the image processing device is capable of reproducing.

5. The method of claim 1, wherein the color gamut of the image processing device is a RGB (red-green-blue) color space or a CIE LAB colorimetric coordinate space.

6. The method of claim 1, wherein the test plane is formed by holding one dimension constant and assigning different values to the two other points.

7. The method of claim 1, wherein the test plane is formed by selecting the test plane which is expected to pass through a fewest number of facets of the at least one polyhedron.

8. The method of claim 7, further comprising estimating a number of facets, which the test plane may intersect by sorting the facets, and choosing the test plane with a fixed x, y, or z value depending on the number of facets are near the x, y, or z value of the test point.

9. The method of claim 1, further comprising for each edge of each facet of the at least one polyhedron, finding an intersection point between the lines containing the edge and a chosen plane.

10. The method of claim 1, further comprising for each facet of the at least one polyhedron whose edges contain two distinct intersection points with the test plane, adding a line segment formed by the two distinct intersection points as an edge of the polygon.

11. The method of claim 1, further comprising selecting an edge to the left when the test ray intersects a shared vertex.

12. The method of claim 1, wherein before performing steps (a)-(e) generating a test ray extending from the test point and checking whether the test ray intersects any facets of the polyhedron at an edge or vertex, and if the test ray does not, counting the number of times the ray crosses the boundary of the polyhedron, wherein if the number of times the test ray crosses the boundary of the polyhedron is even, the test point is outside of the polyhedron, and if the number of times the rays crosses the boundary of the polyhedron is odd, the test point is inside of the polyhedron.

13. The method of claim 12, further comprising if the test ray intersects an edge or vertex, and then performing steps (a)-(e) to determine if the test point is outside of the polyhedron or if the test point is inside of the polyhedron.

14. The method of claim 1, further comprising determining an equivalent color within the color gamut of the image processing device, if the test point does not lie within the at least one polyhedron.

15. A computer program product comprising a non-transitory computer usable medium having a computer readable code embodied therein for controlling a device, the computer readable program code configured to determine if a test point is within a color gamut of an image processing device, the process comprising the steps of:
(a) selecting a test point which may or may not be within the color gamut of the image processing device, and wherein the color gamut of the image processing device is defined by at least one polyhedron;
(b) forming a test plane containing the test point and two other points, and which intersects an inner portion of the at least one polyhedron;
(c) generating a polygon from the intersection of the test plane and an outer boundary of the at least one polyhedron, the polygon having a closed path, which forms a boundary of the polygon;
(d) generating a test ray extending from the test point and which is within the test plane; and
(e) counting a number of times the test ray crosses the boundary of the polygon, and wherein if the number of times the test ray crosses the boundary of the polygon is even, the test point is outside of the at least one polyhedron, and if the number of times the test ray crosses the boundary of the polygon is odd, the test point is inside of the at least one polyhedron.

16. The computer program of claim 15, wherein if the test ray does not extend across the boundary of the polygon, the test point is outside of the at least one polyhedron.

17. The computer program of claim 15, wherein if the test point is inside of the at least one polyhedron, the test point is within the color gamut of the image processing device and wherein if the test point is outside of the at least one polyhedron, the test point is outside the color gamut of the image processing device and further processing is necessary to find a suitable alternative color that the image processing device is capable of reproducing.

18. The computer program of claim 15, wherein before performing steps (a)-(e), generating a test ray extending from the test point and checking whether the test ray intersects any facets of the polyhedron at an edge or vertex, and if the test ray does not, counting the number of times the ray crosses the boundary of the polyhedron, wherein if the number of times the test ray crosses the boundary of the polyhedron is even, the test point is outside of the polyhedron, and if the number of times the rays crosses the boundary of the polyhedron is odd, the test point is inside of the polyhedron.

19. The computer program of claim 18, further comprising if the test ray intersects an edge or vertex, performing steps (a)-(e) to determine if the test point is outside of the at least one polyhedron or if the test point is inside of the at least one polyhedron.

20. An imaging device comprising:
a memory unit, the memory unit having a firmware application, which determines if a test point is within a color gamut of an image processing device, the method comprising:
(a) selecting a test point which may or may not be within the color gamut of the image processing device, and wherein the color gamut of the image processing device is defined by at least one polyhedron;
(b) forming a test plane containing the test point and two other points, and which intersects an inner portion of the at least one polyhedron;
(c) generating a polygon from the intersection of the test plane and an outer boundary of the at least one polyhedron, the polygon having a closed path, which forms a boundary of the polygon;
(d) generating a test ray extending from the test point and which is within the test plane; and
(e) counting a number of times the test ray crosses the boundary of the polygon, and wherein if the number of times the test ray crosses the boundary of the polygon is even, the test point is outside of the at least one polyhedron, and if the number of times the test ray crosses the boundary of the polygon is odd, the test point is inside of the at least one polyhedron.
